(19) United States
(12) Patent Application Publication
(10) Pub. No.: US 2016/0158681 A1
(43) Pub. Date: Jun. 9, 2016

(54) SEPARATOR

(71) Applicant: LG CHEM, LTD., Seoul (KR)

(72) Inventors: Eun Jeong KIM, Daejeon (KR); Ye Hoon IM, Daejeon (KR); Hyun Jin Shin, Daejeon (KR); Jun Won CHOI, Daejeong (KR); Jung Kee JANG, Daejeon (KR)

(21) Appl. No.: 14/867,715

(22) Filed: Sep. 28, 2015

(30) Foreign Application Priority Data
Sep. 30, 2014 (KR) 10-2014-0130686
Sep. 30, 2014 (KR) 10-2014-0130694
Sep. 9, 2015 (KR) 10-2015-0127490

(51) Int. Cl. B01D 45/16

(52) U.S. Cl. CPC B01D 45/16

(57) ABSTRACT

Disclosed here is a separator. The separator includes a cylindrical body in which a spatial portion is provided for separation, a supply pipe provided so that the mixture is introduced in a tangential direction of the cylindrical body to generate a revolving gas flow of the mixture in the spatial portion, a discharge pipe provided so that the first material is discharged to the outside through a rising gas flow of a central portion of the spatial portion, and a deflector provided to be parallel to the supply pipe in a circumferential direction of the spatial portion to prevent the mixture introduced into the spatial portion through the supply pipe from rising.

### CROSS-REFERENCE TO RELATED APPLICATION

This application claims priority to and the benefit of Korean Patent Application No. 10-2014-0130694, filed on Sep. 30, 2014, Korean Patent Application No. 10-2014-0130686, filed on Sep. 30, 2014, and Korean Patent Application No. 10-2015-0127490, filed on Sep. 9, 2015, the disclosure of which is incorporated herein by reference in their entirety.

### BACKGROUND

1. Field of the Invention

The present invention relates to a separator, and more particularly, to a separator configured to discharge a low density material from a mixture of two or more materials having different densities to the outside.

2. Discussion of Related Art

In general, a separator is an apparatus to remove impurities from a mixture of two or more materials and to separate a desired material, and more particularly, to an apparatus to separate particles or droplets included in gases.

Meanwhile, sometimes outlets for droplet or particle impurities cannot be provided because of a state of a high temperature and a high pressure. That is, the gases are discharged to the outside of the separator, and the separated impurities are accumulated in the separator.

The separator used for a hydrogenation process in the Naphtha Cracking Center (NCC) will be described as an example. When a gas mixture including particles is introduced into the separator in a tangential direction, a revolving gas flow is generated according to a flow characteristic of the gas mixture. Here, the particles mixed in the gas fall to the bottom of the separator due to a centrifugal force.

Meanwhile, the particles which flow into the separator may be discharged to the outside of the separator accompanying a rising flow of the gas. Generally, a deflector may be installed to prevent an accompanying rise of the particles.

FIGS. 1 and 2 are conceptual views illustrating a general separator (1).

Referring to FIGS. 1 and 2, a separator 1 includes a cylindrical body (2), a supply pipe (3), a discharge pipe (4), and a deflector (5). Here, the deflector 5 is provided to be inclined downward at a predetermined angle (θ1) in the separator 1 to guide a descending flow of a mixture for accumulating particles.

However, the downward inclined deflector (5) causes problems in that particle trajectories P are unstable and the particles are discharged.

Meanwhile, when the separator is used for a long time, an effective inner space of the separator is reduced due to the particle accumulation, and thus an efficiency of particle separation is decreased. Accordingly, periodically, cleaning for removing the accumulated particles is required in a state in which the system is stopped.

In order to extend the cleaning cycle, a volume of the separator may be increased. For example, a height of the separator may be increased. However, when the separator is extended in a heightwise direction, a phenomenon occurs in which a left or right flow of a rising gas flow generated in a central area of the separator is increased. At this time, the rising gas flow causes an accompanying rise of the particles to be accumulated, and accordingly, there is a problem in that the particles are discharged to the outside of the separator through a gas outlet.

Accordingly, a structure which increases the separator volume and simultaneously improves the efficiency of the particle separation is required.

### SUMMARY OF THE INVENTION

The present invention is directed to provide a separator capable of preventing a mixture introduced into the separator from rising.

In addition, the present invention is directed to provide a separator capable of enhancing a revolving gas flow of a mixture introduced into the separator.

In addition, the present invention is directed to provide a separator capable of improving separation efficiency.

According to an aspect of the present invention, there is provided a separator into which a mixture of two or more materials having different densities is introduced, a first material having a lower density is discharged to the outside, and a second material having a higher density is accumulated therein. The separator includes a cylindrical body in which a spatial portion is provided for separation, a supply pipe provided so that the mixture is introduced in a tangential direction of the cylindrical body to generate a revolving gas flow of the mixture in the spatial portion, a discharge pipe provided so that the first material is discharged to the outside through a rising gas flow of a central portion of the spatial portion, and a deflector provided to be parallel to the supply pipe in a circumferential direction of the spatial portion to prevent the mixture introduced into the spatial portion through the supply pipe from rising.

According to another aspect of the present invention, there is provided a separator into which a mixture of two or more materials having different densities is introduced, a first material having a lower density is discharged to the outside, and a second material having a higher density is accumulated therein. The separator includes a cylindrical body in which a spatial portion is provided for separation, a supply pipe provided so that the mixture is introduced in a tangential direction of the cylindrical body to generate a revolving gas flow of the mixture in the spatial portion, a discharge pipe provided so that the first material is discharged to the outside through a rising gas flow of a central portion of the spatial portion, and a deflector provided to be parallel to the supply pipe in a circumferential direction of the spatial portion to prevent the mixture introduced into the spatial portion through the supply pipe from rising.

Here, the deflector includes a first baffle member which extends from an inner circumferential surface of the cylindrical body, which forms the spatial portion, in a radius direction toward a central portion of the cylindrical body, and a second baffle member which extends downward from the first baffle member in a direction of a central axis of the spatial portion.

According to still another aspect of the present invention, there is provided a separator into which a mixture of two or more materials having different densities is introduced, a first material having a lower density is discharged to the outside, and a second material having a higher density is accumulated therein. The separator includes a cylindrical body in which a spatial portion is provided for separation, a supply pipe provided so that the mixture is introduced in a tangential direction of the cylindrical body to generate a revolving gas flow of the mixture in the spatial portion, a discharge pipe provided so that the gas is discharged to the outside through a rising gas flow of a central portion of the spatial portion, and a deflector provided to prevent the mixture introduced in a circumferential direction of the spatial portion at a predetermined angle from rising, and to prevent the gas at the predetermined angle from spreading toward the central portion of the spatial portion.

According to yet another aspect of the present invention, there is provided a separator which includes a cylindrical body in which a spatial portion is provided for separation, wherein the cylindrical body has a predetermined height and a predetermined diameter, a supply pipe into which a mixture is introduced in a tangential direction of the cylindrical body to generate a revolving gas flow of the mixture in the spatial portion, a discharge pipe provided to discharge the first material to the outside through a rising gas flow of a central portion of the spatial portion, a deflector which is provided to be parallel to the supply pipe in the circumferential direction of the spatial portion to prevent the mixture introduced into the spatial portion through the supply pipe from rising, and an extended pipe which extends in a direction of a central axis of the spatial portion from the discharge pipe to a height lower than that of the supply pipe to transfer the first material to the discharge pipe.

Here, a height of the cylindrical body may be 2.5 times or more a diameter thereof.

In addition, the supply pipe may be connected with the spatial portion through a side surface of an upper portion of the cylindrical body to be perpendicular to a central axis of the cylindrical body, the discharge pipe may be provided on an upper surface of the cylindrical body, and the discharge pipe and the extended pipe may be provided on the same axis as the central axis of the cylindrical body.

In addition, the discharge pipe and the extended pipe may have the same diameter and may be integrally formed.

In addition, the extended pipe, the supply pipe, and the deflector may be arrayed to be sequentially positioned from the bottom surface of the spatial portion of the cylindrical body in a heightwise direction.

According to yet another aspect of the present invention, there is provided a separator which includes a cylindrical body in which a spatial portion is provided for separation, wherein the cylindrical body has a predetermined height and a predetermined diameter, a supply pipe into which a mixture is introduced in a tangential direction of the cylindrical body to generate a revolving gas flow of the mixture in the spatial portion, a discharge pipe provided to discharge the first material to the outside through a rising gas flow of a central portion of the spatial portion, a deflector provided to be parallel to the supply pipe in the circumferential direction of the spatial portion to prevent the mixture introduced into the spatial portion through the supply pipe from rising, and an extended pipe which extends in a direction of a central axis of the spatial portion from the discharge pipe to a height lower than that of the supply pipe to transfer the first material to the discharge pipe.

Here, the deflector may include a first baffle member which extends from an inner circumferential surface of the cylindrical body, which forms the spatial portion, in a radius direction toward a central portion of the cylindrical body, and a second baffle member which extends downward from the first baffle member in a direction of a central axis of the spatial portion.

According to yet another aspect of the present invention, there is provided a separator which includes a cylindrical body in which a spatial portion is provided for separation, wherein the cylindrical body has a predetermined diameter and a height 2.5 times or more the diameter, a supply pipe into which a mixture is introduced in a tangential direction of the cylindrical body to generate a revolving gas flow of the mixture in the spatial portion, a discharge pipe provided to discharge the gas to the outside through a rising gas flow of a central portion of the spatial portion, a deflector provided to prevent the mixture introduced in a circumferential direction of the spatial portion at a predetermined angle from rising, and to prevent the gas at the predetermined angle from spreading toward the central portion of the spatial portion, and an extended pipe which extends in a direction of a central axis of the spatial portion from the discharge pipe to a height lower than that of the supply pipe to transfer the gas to the discharge pipe.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIGS. 1 and 2 are conceptual views illustrating a separator;

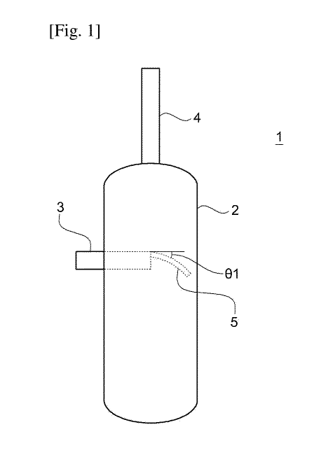

FIG. 3 is a conceptual view of a separator according to a first embodiment of the present invention;

FIG. 4 is a cross-sectional view taken along line A-A shown in FIG. 3;

FIG. 5 is a conceptual view illustrating a flow state of the inside of the separator shown in FIG. 3;

FIG. 6 is a conceptual view of a separator according to a second embodiment of the present invention; and

FIG. 7 is a result of a simulation for describing effects of the separator illustrated in FIG. 6.

### DETAILED DESCRIPTION OF EXEMPLARY EMBODIMENTS

Hereinafter, a separator according to one embodiment of the present invention will be described in detail with reference to the accompanying drawings.

In addition, parts performing similar functions and operations throughout the drawings are denoted by the same or similar reference numerals, redundant description thereof will be omitted, and a shape and a size of the elements in the drawings may be exaggerated for the convenience of description.

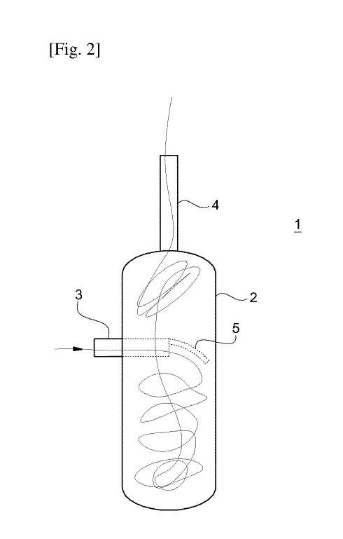

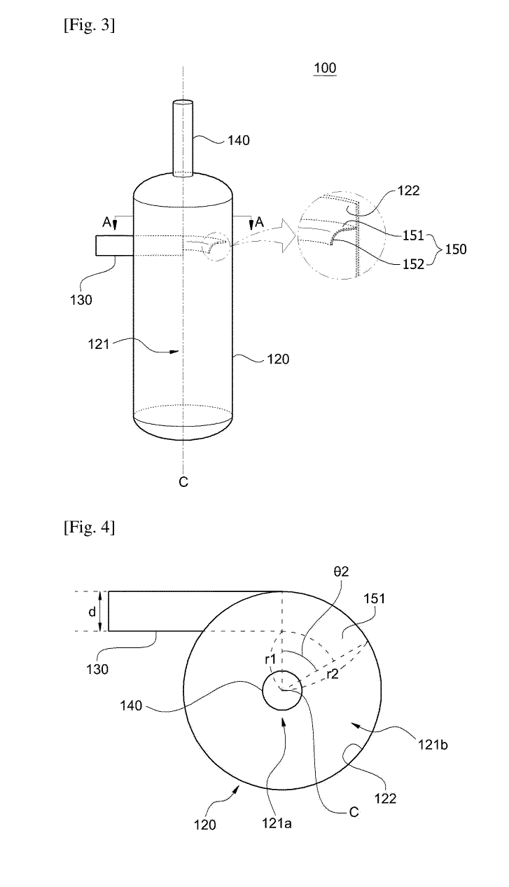

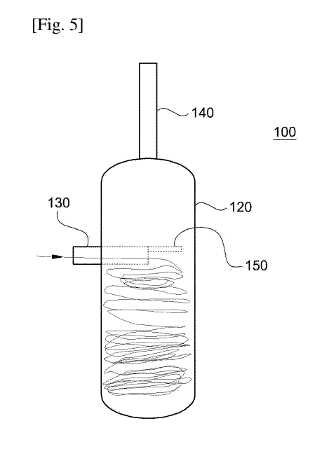

FIG. 3 is a conceptual view of a separator according to a first embodiment of the present invention, FIG. 4 is a cross-sectional view taken along line A-A shown in FIG. 3, and FIG. 5 is a conceptual view illustrating a flow state of the inside of the separator shown in FIG. 3.

In a separator 100 of the present document, a mixture of two or more materials having different densities flows therein, a first material having a lower density is discharged to the outside, and a second material having a higher density is accumulated therein. Here, the first material may be a gas, and the second material, which is an impurity, may be particles or droplets. Particularly, in the separator 100 of the embodiment of the present document, the mixture of the two or more materials including the gas is introduced therein, and more particularly, an outlet for the particle or droplet impurities separated from the gas is not separately provided because of a state of a high temperature, a high pressure, etc.

As an embodiment, the separator 100 may be a separator installed for a hydrogenation process of the Naphtha Cracking Center (NCC). Specifically, when the gas mixture including particles is introduced into the separator 100 in a tangential direction thereof, a revolving gas flow is generated according to a flow characteristic of the gas mixture introduced in the tangential direction. At this time, a rising gas flow is generated in a central portion 121a of the inside of the separator 100, and a descending gas flow is generated at a circumferential portion 121b. Here, the particles mixed in the gas by a centrifugal force fall to the bottom of the separator 100. In addition, the gas is discharged to the outside of the separator 100 by the rising gas flow.

The separator 100 includes a cylindrical body 120 in which a spatial portion 121 is provided for separation. The cylindrical body 120 has a structure in which a height is formed to be greater than a diameter. In addition, a non-described reference character C refers to a central axis of the cylindrical body 120 and the spatial portion 121.

The separator 100 includes a supply pipe 130 and a discharge pipe 140. The mixture is introduced through the supply pipe 130 into the spatial portion 121 of the separator 100. In addition, a separated first material (i.e., a gas) is discharged to the outside of the separator 100 through the discharge pipe 140.

The supply pipe 130 is provided so that the mixture is introduced in a tangential direction of the cylindrical body 120 to generate the revolving gas flow of the mixture in the spatial portion 121. In addition, the discharge pipe 140 is provided so that the first material (i.e., a gas) is discharged to the outside through the rising gas flow of the central portion 121a of the spatial portion 121.

In addition, the separator 100 includes a deflector 150. Here, the deflector 150 is provided to be parallel to the supply pipe 130 in a circumferential direction of the spatial portion 121 to prevent the mixture introduced into the spatial portion 121 through the supply pipe 130 from rising.

Referring to FIGS. 3 and 4, the deflector 150 may extend from an inner circumferential surface 122 of the cylindrical body 120 which forms the spatial portion 121 in a radius direction toward the central portion 121a of the cylindrical body 120. As an embodiment, the deflector 150 may have a fan shape of which a central portion is cut with respect to the central axis C of the spatial portion 121. The deflector 150 may be a plate which has an outer circumferential edge in an arc shape and an inner circumferential edge in an arc shape.

In addition, the deflector 150 may be provided to be perpendicular to the central axis C of the spatial portion 121. Specifically, the deflector 150 is provided to prevent the mixture introduced into the spatial portion 121 from rising, and is not provided to guide a descending flow of the mixture. Referring to FIG. 5, since the deflector 150 is provided to be parallel to the supply pipe 130, the deflector 150 performs a function which further enhances the revolving gas flow of the mixture discharged from the supply pipe 130.

The deflector 150 may be provided so that a width (r2-r1) which extends in the radius direction is the same as a diameter d of the supply pipe 130. In addition, the deflector 150 may be provided so that the width (r2-r1) which extends in the radius direction is greater than or equal to the diameter d of the supply pipe 130. Specifically, the deflector 150 is provided to surround the circumferential portion 121b in the circumferential direction rather than surrounding the central portion 121a of the spatial portion 121 including the central axis C.

In addition, deflector 150 may be provided to extend 45° or more in the circumferential direction with respect to the central axis C of the spatial portion 121. Preferably, the deflector 150 may be provided to extend 45° to 180° in the circumferential direction with respect to the central axis C of the spatial portion 121. Specifically, the deflector 150 may extend as much as a predetermined angle in the circumferential direction with respect to the central axis C of the spatial portion 121 to correspond to the revolving gas flow of the mixture from an area in which the mixture is discharged from the supply pipe 130.

Here, in the deflector 150, an entire area in the circumferential direction with respect to the central axis C of the spatial portion 121 may be provided to be parallel to the supply pipe 130.

In addition, each of the supply pipe 130 and the deflector 150 may be provided to be perpendicular to the central axis C of the cylindrical body 120. Additionally, the discharge pipe 140 may be provided on the same axis as the central axis C of the cylindrical body 120. Specifically, the supply pipe 130 may be provided to be connected with the spatial portion 121 through a side surface of an upper portion of the cylindrical body 120, and the discharge pipe 140 may be provided to be connected with the spatial portion 121 through an upper surface of the cylindrical body 120.

The deflector 150 which is the parallel plate provided to prevent the mixture introduced from the supply pipe 130 from rising has been described above. However, the embodiment of the present invention may not be limited thereto, and the deflector 150 may be provided not only to prevent the mixture introduced by the supply pipe 130 from rising, but also to prevent the gas from spreading toward the central portion 121a.

To this end, the deflector 150 includes a first baffle member 151 which extends in the radius direction toward the central portion 121a of the cylindrical body 120 from the inner circumferential surface 122 of the cylindrical body 120 which forms the spatial portion 121, and a second baffle member 152 which extends downward from the first baffle member 151 in a direction of the central axis C of the spatial portion 121.

Here, the first baffle member 151 performs a function to prevent the mixture introduced by the supply pipe 130 from rising, and the second baffle member 152 performs a function to prevent the gas from spreading toward the central portion 121a.

As an embodiment, the separator 100 is a separator into which the mixture including the gas and the particles is introduced, the gas is discharged to the outside, and the particles are accumulated therein, and the deflector 150 is provided to prevent the mixture introduced in the circumferential direction of the spatial portion 121 from rising in a predetermined angle range θ2, and prevent the gas from spreading toward the central portion 121a of the spatial portion 121 in the predetermined angle range θ2.

As described above, the first baffle member 151 may have a fan shape of which a center is cut based on the central axis of the spatial portion 121. In addition, the first baffle member 151 may be provided to be perpendicular to the central axis C of the spatial portion 121.

In addition, since the first baffle member 151 is provided to be parallel to the supply pipe 130, the first baffle member 151 performs a function to further enhance the revolving gas flow of the mixture discharged from the supply pipe 130.

The first baffle member 151 may be provided so that a width (r2-r1) which extends in the radius direction is the same as the diameter d of the supply pipe 130. In addition, the first baffle member 151 may be provided so that the width (r2-r1) which extends in the radius direction is greater than or equal to the diameter d of the supply pipe 130. Specifically, the first baffle member 151 is provided to surround the circumferential portion 121b in the circumferential direction rather than surrounding the central portion 121a of the spatial portion 121 including the central axis C.

In addition, the first baffle member 151 may be provided to 45° or more in the circumferential direction with respect to the central axis C of the spatial portion 121. Preferably, the first baffle member 151 may be provided to extend in a range of 45° to 180° in the circumferential direction with respect to the central axis C of the spatial portion 121.

Here, for the first baffle member 151, the entire area in the circumferential direction with respect to the central axis C of the spatial portion 121 may be provided to be parallel to the supply pipe 130.

In addition, each of the supply pipe 130 and the first baffle member 151 may be provided to be perpendicular to the central axis C of the cylindrical body 120.

In addition, the first baffle member 151 and the second baffle member 152 may be provided to be inclined at predetermined angles. As an embodiment, the first baffle member 151 and the second baffle member 152 may be provided to be perpendicular to each other. Here, a boundary portion of the first baffle member 151 and the second baffle member 152 may be rounded. In addition, the first baffle member 151 may include a fixed end fixed to the inner circumferential surface 122 of the cylindrical body 120 and a free end disposed to be opposite the fixed end. In addition, each of the fixed end and the free end may have an arc shape. In addition, the second baffle member 152 may extend downward in the direction of the central axis C from the free end of the first baffle member 151.

In addition, a height of the second baffle member 152 which extends parallel to the direction of the central axis C may be less than the width (r2-r1) of the first baffle member 151 which extends in the radius direction. In addition, the first baffle member 151 may be provided in contact with an outer circumferential surface of the supply pipe 130. That is, the outer circumferential surface of the supply pipe 130 and the deflector 150 may be formed to be connected with each other at at least parts of areas thereof.

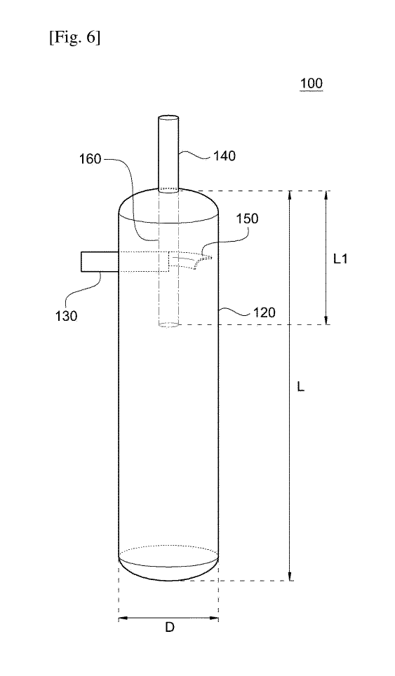

FIG. 6 is a conceptual view of a separator according to a second embodiment of the present invention.

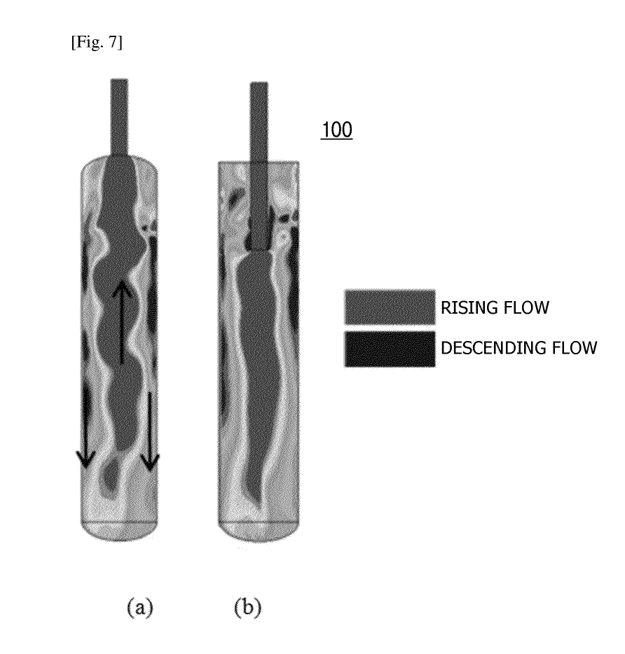

FIG. 7 is a result of a simulation for describing effects of the separator illustrated in FIG. 6.

Referring to FIG. 6, the above-described cylindrical body 120 has a predetermined diameter D and height L. Here, the height L may be 2.5 times or more the diameter D. In the cylindrical body 120 which has the height 2.5 times or more the diameter, the centrifugal force which acts on the particles increases, and left and right vibration of the rising gas flow generated from the central portion 121a of the cylindrical body 120 also increases (see FIG. 7(A)). In this case, the particles may be caught by the rising gas flow and discharged through the discharge pipe 140 to the outside of the separator 100.

To prevent this, the separator 100 includes an extended pipe 160 which extends from the discharge pipe 140 to a height lower than that of the supply pipe 130 in a heightwise direction of the spatial portion 121 to transfer the first material (i.e., a gas) to the discharge pipe 140.

As described above, the supply pipe 130 is provided to be connected with the spatial portion 121 through a side surface of an upper portion of the cylindrical body 120 to be perpendicular to the central axis C of the cylindrical body 120. In addition, the discharge pipe 140 is provided on the upper surface of the cylindrical body 120. Here, the discharge pipe 140 and the extended pipe 160 may be provided on the same axis as the central axis C of the cylindrical body 120.

In addition, the discharge pipe 140 and the extended pipe 160 may have the same diameter and be integrally formed. In addition, a length L1 of the extended pipe 160 may be decided to be greater than a sum of a distance from the upper surface of the cylindrical body 120 to the supply pipe 130 and the diameter d of the supply pipe 130. That is, the extended pipe 160 extends to a height lower than that of the supply pipe 130 with respect to the bottom surface of the cylindrical body 120. Accordingly, the extended pipe 160, the supply pipe 130, and the deflector 150 may be sequentially positioned from the bottom surface of the spatial portion of the cylindrical body 120 in the heightwise direction.

FIG. 7(B) is a result of a simulation when the extended pipe 160 is provided, and FIG. 7(A) is a result of a simulation when the extended pipe is not provided.

Referring to FIG. 7(B), it is confirmed that the left and right vibration of the rising gas flow is reduced in the separator 100 according to the embodiment.

As described above, the separator according to at least one embodiment of the present invention has the following effects.

The rising flow of the mixture introduced into the inside of the separator through the deflector provided to be parallel to the supply pipe can be prevented. In addition, the revolving gas flow of the mixture introduced into the inside of the separator can be further enhanced to improve the separation efficiency.

In addition, the separator volume can be increased even without decreasing the separation efficiency. Accordingly, the cleaning cycle can be extended.

The exemplary embodiments of the present invention described above are disclosed only for examples, it will be understood by those skilled in the art that various changes, modifications, and alternations may be made without departing from the spirit and scope of the invention, and the various changes, modifications, and alternations are within the appended claims.

What is claimed is:

1. A separator into which a mixture of two or more materials having different densities is introduced, a first material having a lower density is discharged to the outside, and a second material having a higher density is accumulated therein, the separator comprising:
a cylindrical body in which a spatial portion is provided for separation;
a supply pipe provided so that the mixture is introduced in a tangential direction of the cylindrical body to generate a revolving gas flow of the mixture in the spatial portion;
a discharge pipe provided so that the first material is discharged to the outside through a rising gas flow of a central portion of the spatial portion; and
a deflector provided to be parallel to the supply pipe in a circumferential direction of the spatial portion to prevent the mixture introduced into the spatial portion through the supply pipe from rising.

2. The separator of claim 1, wherein the deflector extends in a radius direction toward a central portion of the cylindrical body from an inner circumferential surface of the cylindrical body which forms the spatial portion.

3. The separator of claim 2, wherein the deflector is provided to have a fan shape of which a central portion is cut with respect to a central axis of the spatial portion, and to be perpendicular to the central axis of the spatial portion.

4. The separator of claim 2, wherein a width of the deflector which extends in the radius direction is provided to be the same as a diameter of the supply pipe.

5. The separator of claim 2, wherein the deflector extends 45° or more in the circumferential direction with respect to a central axis of the spatial portion.

6. The separator of claim 1, wherein the deflector is provided to extend in a range of 45° to 180° in the circumferential direction with respect to a central axis of the spatial portion.

7. The separator of claim 1, wherein an entire area of the deflector in the circumferential direction is provided to be parallel to the supply pipe with respect to a central axis of the spatial portion.

8. The separator of claim 1, wherein each of the supply pipe and the deflector is provided to be perpendicular to a central axis of the cylindrical body.

9. The separator of claim 8, wherein the discharge pipe is provided on the same axis as the central axis of the cylindrical body.

10. The separator of claim 9, wherein the supply pipe is connected with the spatial portion through a side surface of an upper portion of the cylindrical body, and the discharge pipe is connected with the spatial portion through an upper surface of the cylindrical body.

11. The separator of claim 1, wherein the first material includes a gas, and the second material includes a droplet or particle.

12. A separator into which a mixture of two or more materials having different densities is introduced, a first material having a lower density is discharged to the outside, and a second material having a higher density is accumulated therein, the separator comprising:
a cylindrical body in which a spatial portion is provided for separation;
a supply pipe provided so that the mixture is introduced in a tangential direction of the cylindrical body to generate a revolving gas flow of the mixture in the spatial portion;
a discharge pipe provided so that the first material is discharged to the outside through a rising gas flow of a central portion of the spatial portion; and
a deflector provided to be parallel to the supply pipe in a circumferential direction of the spatial portion to prevent the mixture introduced into the spatial portion through the supply pipe from rising,
wherein the deflector includes:
a first baffle member which extends from an inner circumferential surface of the cylindrical body, which forms the spatial portion, in a radius direction toward a central portion of the cylindrical body; and
a second baffle member which extends downward from the first baffle member in a direction of a central axis of the spatial portion.

13. The separator of claim 12, wherein the first baffle member is provided to have a fan shape of which a central portion is cut with respect to the central axis of the spatial portion, and to be perpendicular to the central axis of the spatial portion.

14. The separator of claim 12, wherein a width of the first baffle member which extends in the radius direction is provided to have the same diameter of the supply pipe.

15. The separator of claim 14, wherein the first baffle member is provided to extend in a range of 45° to 180° in the circumferential direction with respect to the central axis of the spatial portion.

16. The separator of claim 12, wherein the first baffle member and the second baffle member are provided to be inclined at predetermined angles.

17. A separator into which a mixture of two or more materials having different densities is introduced, a first material having a lower density is discharged to the outside, and a second material having a higher density is accumulated therein, the separator comprising:
a cylindrical body in which a spatial portion is provided for separation, wherein the cylindrical body has a predetermined height and a predetermined diameter;
a supply pipe into which a mixture is introduced in a tangential direction of the cylindrical body to generate a revolving gas flow of the mixture in the spatial portion;
a discharge pipe provided to discharge the first material to the outside through a rising gas flow of a central portion of the spatial portion;
a deflector provided to be parallel to the supply pipe in the circumferential direction of the spatial portion to prevent the mixture introduced into the spatial portion through the supply pipe from rising; and
an extended pipe which extends in a direction of a central axis of the spatial portion from the discharge pipe to a height lower than that of the supply pipe to transfer the first material to the discharge pipe.

18. The separator of claim 17, wherein a height of the cylindrical body is 2.5 times or more a diameter thereof.

19. The separator of claim 17, wherein the supply pipe is connected with the spatial portion through a side surface of an upper portion of the cylindrical body to be perpendicular to a central axis of the cylindrical body, the discharge pipe is provided on an upper surface of the cylindrical body, and the discharge pipe and the extended pipe are provided on the same axis as the central axis of the cylindrical body.

20. The separator on claim 19, wherein the discharge pipe and the extended pipe have the same diameter and are integrally formed.
